(19) United States
(12) Patent Application Publication
(10) Pub. No.: US 2007/0234645 A1
(43) Pub. Date: Oct. 11, 2007

(54) Door

(76) Inventor: Timothy Francis Costello, Kilfergus (IE)

Correspondence Address: BIRCH STEWART KOLASCH & BIRCH, PO BOX 747, FALLS CHURCH, VA, 22040-0747, US

(21) Appl. No.: 11/597,611

(22) PCT Filed: Apr. 29, 2005
(86) PCT No.: PCT/IE05/00049

§ 371 Date: Nov. 27, 2006

(30) Foreign Application Priority Data
May 31, 2004 (IE) 2004/0381

(51) Int. Cl. E06B 3/86

(52) U.S. Cl. 49/501

(57) ABSTRACT

A door (10) is constructed from a pair of identical plastics subunits (11, 18), each subunit (11, 18) having an outer plastics skin (14) with a plurality of upstanding formations (12, 19) arranged on the inwardly facing surface (13, 20) thereof. The door (10) is assembled by aligning the upstanding formations (12, 19) on the pair of plastics subunits (11, 18), followed by bonding them together with adhesive along the but-joints (21). The structure of the door (10) gives it a greater strength than a corresponding conventional plastics laminate door with a low-density polyurethane core, without adding to the overall weight of the door (10).

### TECHNICAL FIELD

This invention relates to a door and, in particular, to a door constructed from plastics material.

The invention also relates to a plastics subunit for the door, in accordance with the invention.

### BACKGROUND ART

A door constructed from a core member sandwiched between two plastics laminates is known. The core may be of light wooden construction or can be formed from a synthetic resin. The plastics laminates are moulded from a thermosplastics sheet and can have a variety of surface decorative features and textures, depending on the mould used.

Such a door may be substituted for a traditional door of wooden construction and, if the mould and forming technique are of a high standard, the resultant plastics laminated door has the appearance of an actual wooden door.

Where the core material is a synthetic resin, a low-density polyurethane foam is commonly used. The density of this polyurethane core is usually in the range 40-60 kg/M³. Such doors are susceptible to impact damage on either side thereof.

Certain door designs feature a glazed section or sections. However, these glazed sections have to be fitted to the door following assembly of the sandwich made from the core and a front and rear plastics laminate. This means that an opening has to be cut in the door through both laminates and the core, into which the glazed section is to be fitted. The opening is usually cut through these three layers through a panel delineated on the laminate surface. A rebate is then cut from the rear of the door for receiving the glazed section from the rear. The glazed section is held in place by clips and a slip is placed over the clips from the rear to tidy up the appearance of the rear of the door.

However, when such a door is assembled using a clear glazed section, it is necessary to carefully align the front and rear laminates, as any misalignment will be discernable through the glass.

It is an object of the present invention to overcome the disadvantages of the doors hereinbefore described.

### DISCLOSURE OF INVENTION

Thus, the invention provides a door comprising a pair of identical plastics subunits joined back-to-back, each subunit having an outer plastics skin with a plurality of upstanding formations arranged on the inwardly facing surface thereof, the upstanding formations on one subunit being aligned with those on the other subunit to form the door, which has a monocoque structure.

By a monocoque structure herein is meant that each plastics subunit is constructed such that the plastics skin, spread across the upstanding formations, contributes to the overall strength of the door.

An advantage of the door according to the invention is that it has greater strength than a corresponding conventional plastics laminate door with a low-density polyurethane core, without adding to the overall weight of the door.

When the pair of plastics subunits is aligned to form the door, the upstanding formations on each plastics subunit join to form a strong core for the door. However, as the formations are arranged on the plastics skins prior to joining the plastics subunits together, the resulting plastics subunits are stronger than those of the conventional door, where the plastics laminate sheets are stuck onto a low-density polyurethane core, top form a three component door.

The alignment of the plastics subunits can be facilitated by the addition of locating pins on the upstanding formations.

Preferably, the upstanding formations are formed from high-density polyurethane foam.

The use of high-density polyurethane foam to form the upstanding formations results in a strong backbone for the plastics skin.

Further, preferably, the polyurethane foam has a density within the range 300 to 700 kg/M³.

Most, preferably, the polyurethane foam has a density within the range 400 to 600 kg/m³.

In one embodiment of the door according to the invention, the door has a layer of glass fibre material on the inner surface of each plastics subunit, to which surface the plurality of upstanding formations is attached.

The use of a layer of glass fibre material adds strength to the areas of the plastics skin between the upstanding formations, in turn resulting in a strengthened door.

Preferably, the plurality of upstanding formations is so arranged that a border of the inner surface of each plastics subunit around the periphery thereof is kept free of upstanding formations.

The advantage of this border is that the dimensions of the finished door can be adjusted to suit a particular requirement by removal of some of the plastics skins around the edge of the door.

In a further embodiment of the door according to the invention, the door has a frame member mounted between the pair of plastics subunits around the periphery of the door, the frame member having a rebate formed in the outer edge thereof.

The addition of a frame member is one way of finishing off the assembly of the door. The addition of a rebate allows door furniture such as a lock and hinges to be fixed to the door.

Preferably, the rebate is moulded from high-density polyurethane material.

The use of a rebate moulded from high-density polyurethane makes it easier to fit the door furniture at the positions on the door necessary for a particular application. There is no restriction on the positioning of the door furniture as the necessary mortises can be machined in the polyurethane foam material anywhere along it length.

The invention also provides a plastics subunit for a door as hereinbefore described.

### BRIEF DESCRIPTION OF THE DRAWINGS

The invention will be further illustrated by the following description of embodiments thereof, given by way of example only with reference to the accompanying drawings in which:

FIG. 1 is a front elevation of a door, in accordance with the invention;

FIG. 2 is the cross-section, in perspective, on line II-II of FIG. 1;

FIG. 3 is a view, in perspective, of part of a plastics subunit, in accordance with the invention;

FIG. 4 is a cross-section, in perspective, on line IV-IV of FIG. 3;

FIG. 5 is a schematic view, in cross-section, of a first step in the production of a plastics subunit, in accordance with the invention;

FIG. 6 is a schematic view, in cross-section, of a further step in the production of the plastics subunit of FIG. 5;

FIG. 7 is a schematic view, in cross-section, of a further step in the production of the plastics subunit of FIG. 5; and

FIG. 8 is a schematic view, in cross-section, of the completed plastics subunit of FIG. 5, with the plurality of upstanding formations attached thereto.

### MODES FOR CARRYING OUT THE INVENTION

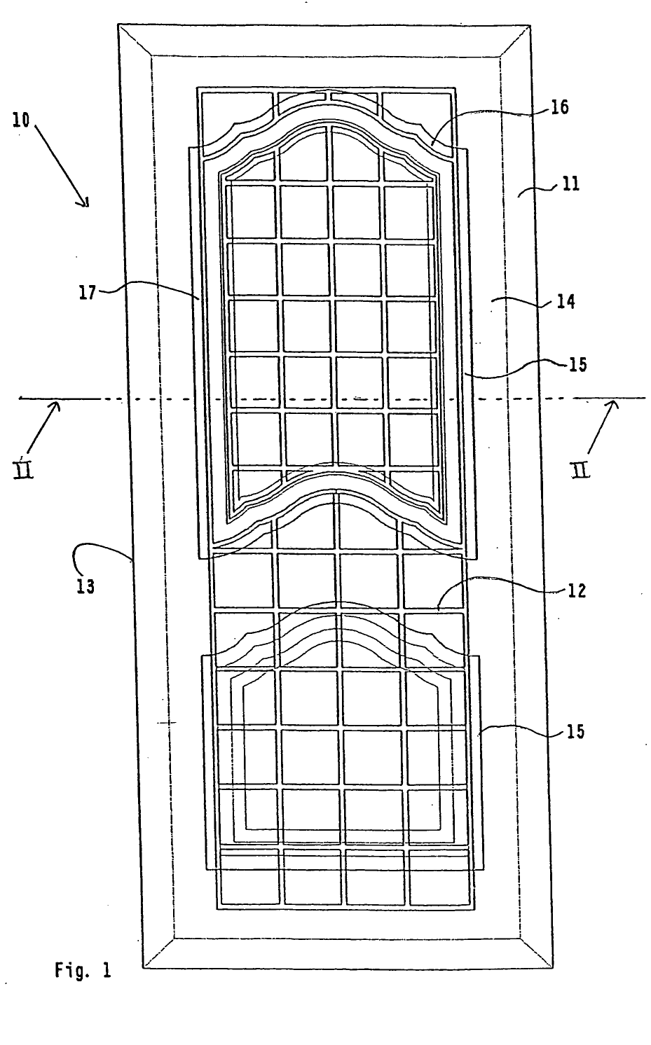

Referring to FIG. 1 there is illustrated generally at 10, a rear elevation of a door, in accordance with the invention, which is constructed from a rear plastics subunit 11 having a plurality of upstanding formations 12 arranged on the inwardly facing surface 13 thereof. In FIG. 1 the upstanding formations 12 are shown in bold outline for the sake of clarity. However, in reality, the upstanding formations 12 would not be visible from the exterior of the door 10.

An outer plastics skin 14 on the rear plastics subunit 11 is moulded in a pressure forming machine from poly(methyl methacrylate) material (PMMA) and has mouldings 15 thereon, which mimic the mouldings on a wooden door of similar design.

The upstanding formations 12 follow the contours 16 of the mouldings 15 around an upper panel 17 in the door 10, which strengthens the door in this area.

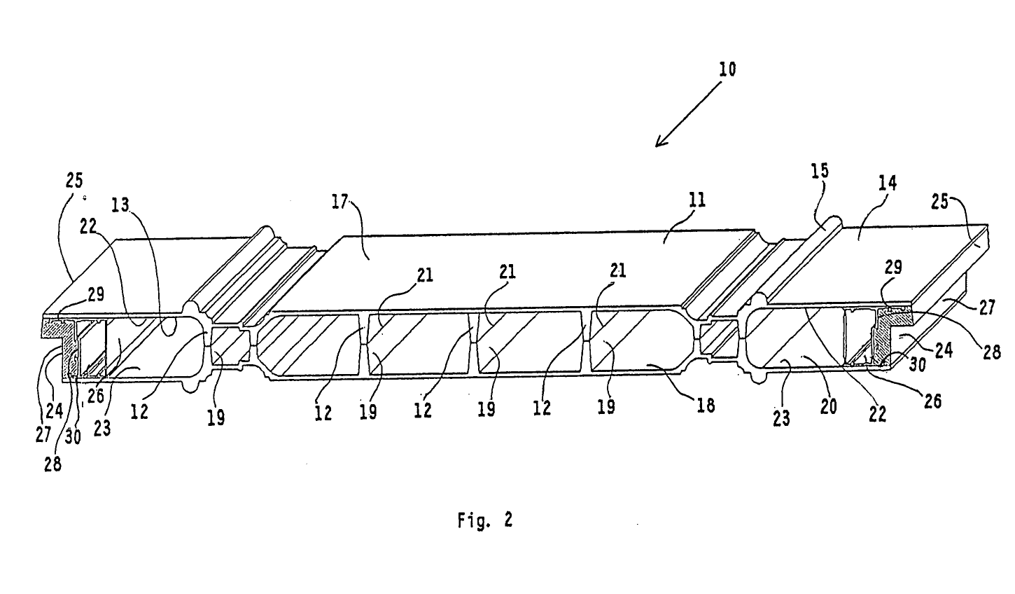

Referring to FIG. 2, the structure of the door 10 can be seen in more detail. The door 10 is constructed from the rear plastics subunit 11 and a front plastics subunit 18. Each of the pair of plastics subunits 11, 18 is identical, with the front plastics subunit 18 also having a plurality of upstanding formations 19 on an inwardly facing surface 20 thereof. The upstanding formations 12, 19 are formed from high-density polyurethane foam having a density of 500 kg/m³, and are attached to the respective plastics subunits 11, 18, prior to the assembly of the door 10 therefrom.

To assemble the door 10, the upstanding formations 12, 19 on the pair of plastics subunits 1 1, 18, respectively, are aligned and glued together along but-joints 21.

A pair of opposed borders 22, 23 on the inner surfaces 13, 20, respectively, are free of upstanding formations. This feature allows the door 10 to be cut to a required size following the gluing together of the pair of plastics subunits 11, 18.

A frame member 24 is mounted between the plastics subunits 11, 18 around the periphery 25 of the door 10. The frame member 24 is in the form of a longitudinal metallic member 26, having a rectangular cross-section, to which a rebate 27 is attached along the outer edge 28 thereof. The rebate 27 is attached by means of flanges 29, 30, which extend from the longitudinal metallic member 26.

In this embodiment, the door 10 is of a type known as a double rebate door. Thus, when the door 10 is hung in a frame and is closed, the rebate 27 sits into a complementary rebate on the frame thus providing an efficient means of draft exclusion.

The rebate 27 is moulded from high-density polyurethane foam and can be machined anywhere along its length for the purpose of fitting hinges, locks, etc., therein.

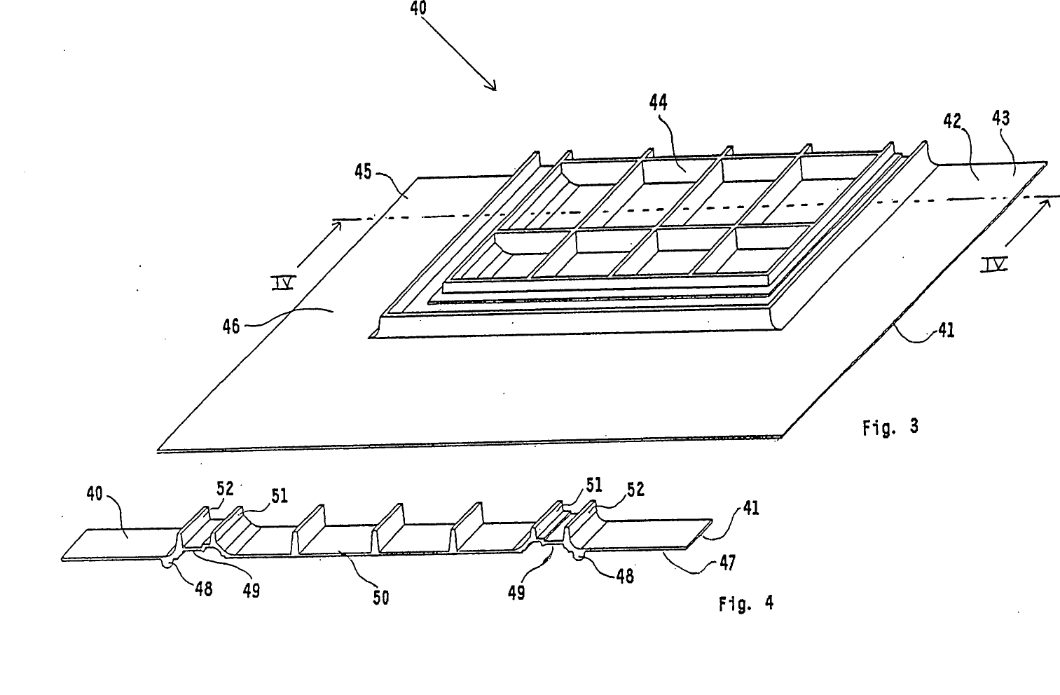

Referring to FIG. 3, there is illustrated, generally at 40, part of a plastics subunit for a door, in accordance with the invention, having a plastics skin 41 with a backing layer 42 of glass fibre material on the inner surface 43 thereof. A plurality of upstanding formations 44 is arranged on the backing layer 42. The upstanding formations 44 do not extend to the edge 45 of the backing layer 42. Thus, a border area 46 is defined around the edge 45.

Referring to FIG. 4, which is a cross-section of a portion of the plastics subunit of FIG. 3, the outer surface 47 of the plastics skin 41 has mouldings 48 thereon, which define a border 49 of a panel 50 therein. Particular formations 51, 52, of the upstanding formations 44, follow the border 49 thus adding strength to the plastics skin 41 in this area.

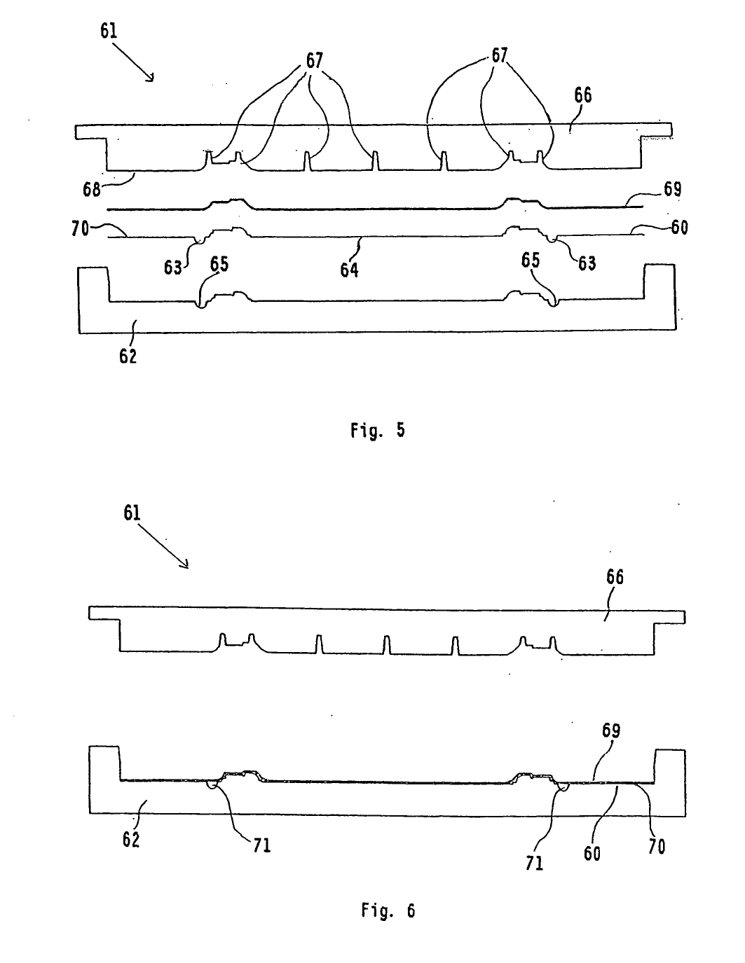

FIGS. 5 to 8 illustrate a method of producing a plastics subunit, in accordance with the invention.

Referring to FIG. 5, a plastics skin 60, which has been formed in a pressure forming machine, is shown suspended within a mould, shown generally at 61. The mould 61 has a first half 62 into which the surface features 63 on the outer surface 65 of the plastics skin will sit, due to the provision of complementary features 65 thereon.

Second half 66 of the mould 61 has a set of features 67 on a surface 68 thereof and this set of features 67 define the shape of a plurality of upstanding formations 74 (FIG. 8), which form part of the finished plastics subunit 73 (FIG. 8).

A sheet of glass fibre material 69 is also shown suspended within the mould 61 over the inner surface 70 of the plastics skin 60.

Referring to FIG. 6, the plastics skin 60 and the sheet of glass fibre material 69 are shown placed in the mould 61, with the sheet of glass fibre material 69 overlying the inner surface 70 of the plastics skin 60, while leaving some air pockets 71 therebetween.

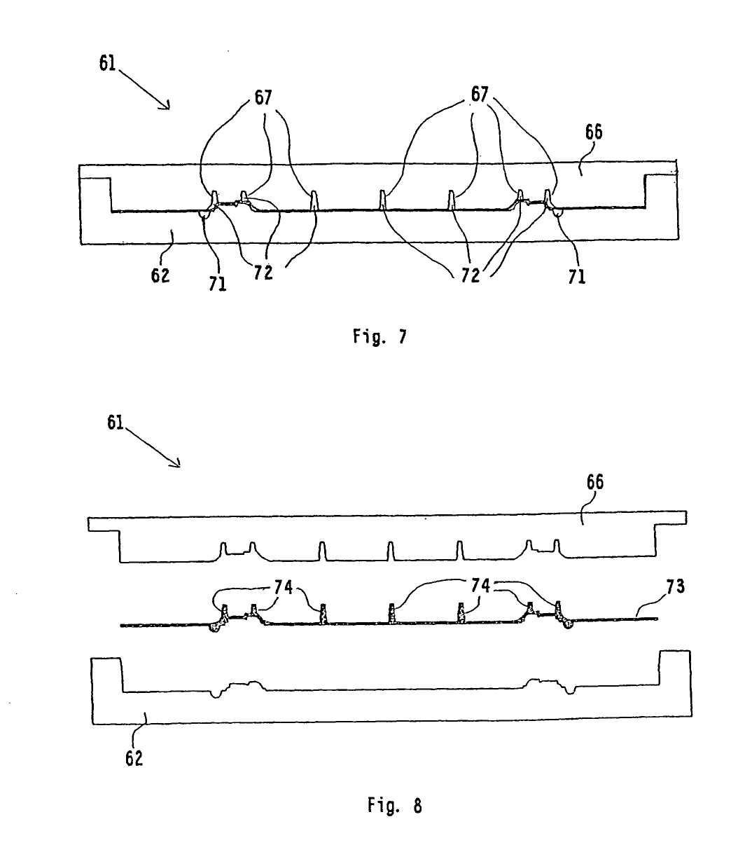

Referring to FIG. 7, the two halves 62, 66 of the mould 61 have been closed together in preparation for the injection of a high-density polyurethane foam, having a density of 500 kg/m³, into the mould 61. The foam will fill the voids 72 in the second half 66 of the mould 61 and at the same time will wet out the sheet of glass fibre material 69, thus eliminating the air pockets 71.

The plastics skin 60 and the sheet of glass fibre material 69 are bonded together using a suitable polyurethane adhesive.

Referring to FIG. 8, once the polyurethane foam has cured, the mould 60 is reopened and the finished plastics subunit 73, with the plurality of upstanding formations 74 thereon, can be removed from the mould 61.

1. A door, comprising a pair of identical plastics subunits joined back-to-back, each subunit having an outer plastics skin with a plurality of upstanding formations arranged on the inwardly facing surface thereof, the upstanding formations not being visible from the outside of the door, and the upstanding formations on one subunit being aligned with those on the other subunit to form the door, which has a monocoque structure.

2. A door according to claim 1, wherein the upstanding formations are formed from high-density polyurethane foam.

3. A door according to claim 1, wherein the polyurethane foam has a density within the range 300 to 700 kg/m³.

4. A door according to claim 1, wherein the polyurethane foam has a density within the range 400 to 600 kg/m³.

5. A door according to claim 1, having a layer of glass fibre material on the inner surface of each plastics subunit, to which surface the plurality of upstanding formations is attached.

6. A door according to claim 1, wherein the plurality of upstanding formations is so arranged that a border of the inner surface of each plastics subunit around the periphery thereof is kept free of upstanding formations.

7. A door according to claim 1, having a frame member mounted between the pair of plastics subunits around the periphery of the door, the frame member having a rebate formed in the outer edge thereof.

8. A door according to claim 7, wherein the rebate is moulded from high-density polyurethane material.

9. A plastics subunit for a door, comprising an outer plastics skin with a plurality of upstanding formations arranged on the inner surface thereof, the upstanding formations not being visible from the outside of the door, and such that, in use, the door is assembled by aligning the upstanding formations on a first plastics subunit with those on a second plastics subunit and joining the subunits together to form a monocoque structure.

10. A plastics subunit according to claim 9, wherein the upstanding formations are formed from high-density polyurethane foam.

11. A plastics subunit according to claim 9, wherein the polyurethane foam has a density within the range 300 to 700 kg/m³.

12. A plastics subunit according claim 9, wherein the polyurethane foam has a density within the range 400 to 600 kg/m³.

13. A plastics subunit according to claim 9, having a layer of glass fibre material on the inner surface thereof to which the plurality of upstanding formations is attached.

14. A plastics subunit according to claim 9, wherein the plurality of upstanding formations is so arranged that a border of the inner surface of the plastics subunit around the periphery thereof is kept free of upstanding formations.

15. (canceled)

16. (canceled)
